(19) United States
(12) Patent Application Publication
(10) Pub. No.: US 2008/0248369 A1
(43) Pub. Date: Oct. 9, 2008

(54) FUEL CELL SYSTEM WITH FLAME ARRESTING RECOMBINER

(76) Inventors: Jacob W. De Vaal, Coquitlam (CA); Rudolf Jacobus Coertze, Coquitlam (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/696,302

(22) Filed: Apr. 4, 2007

(51) Int. Cl. H01M 8/04

(52) U.S. Cl. 429/34

(57) ABSTRACT

A fuel cell system is disclosed comprising a housing having an interior space fluidly containing a fuel cell stack and a flame arresting recombiner, wherein: (1) the flame arresting recombiner comprises at least one fuel cell having at least one anode supply channel fluidly connecting the fuel cell and the interior space of the housing; and (2) the anode supply channel of the fuel cell of the flame arresting recombiner is configured to prevent flame propagation.

### BACKGROUND OF THE INVENTION

1. Field of the Invention

The present invention relates generally to fuel cell systems, and, more particularly, to a fuel cell system comprising a flame arresting recombiner.

2. Description of the Related Art

Electrochemical fuel cells convert reactants, namely fuel and oxidant fluid streams, to generate electric power and reaction products. Electrochemical fuel cells generally employ an electrolyte disposed between two electrodes, namely a cathode and an anode. An electrocatalyst, disposed at the interfaces between the electrolyte and the electrodes, typically induces the desired electrochemical reactions at the electrodes. The location of the electrocatalyst generally defines the electrochemically active area.

One type of electrochemical fuel cell is the polymer electrolyte membrane (PEM) fuel cell. PEM fuel cells generally employ a membrane electrode assembly (MEA) comprising a solid polymer electrolyte or ion-exchange membrane disposed between two electrodes. Each electrode typically comprises a porous, electrically conductive substrate, such as carbon fiber paper or carbon cloth, which provides structural support to the membrane and serves as a fluid diffusion layer. The membrane is ion conductive (typically proton conductive), and acts both as a barrier for isolating the reactant streams from each other and as an electrical insulator between the two electrodes. A typical commercial PEM is a sulfonated perfluorocarbon membrane sold by E.I. Du Pont de Nemours and Company under the trade designation NAFION®. The electrocatalyst is typically a precious metal composition (e.g., platinum metal black or an alloy thereof) and may be provided on a suitable support (e.g., fine platinum particles supported on a carbon black support).

In a fuel cell, a MEA is typically interposed between two separator plates that are substantially impermeable to the reactant fluid streams. The plates typically act as current collectors and provide support for the MEA. In addition, the plates may have reactant channels formed therein and act as flow field plates providing access for the reactant fluid streams to the respective porous electrodes and providing for the removal of reaction products formed during operation of the fuel cell.

In a fuel cell stack, a plurality of fuel cells are connected together, typically in series, to increase the overall output power of the assembly. In such an arrangement, one side of a given separator plate may serve as an anode flow field plate for one cell and the other side of the plate may serve as the cathode flow field plate for the adjacent cell. In this arrangement, the plates may be referred to as bipolar plates. Typically, a plurality of inlet ports, supply manifolds, exhaust manifolds and outlet ports are utilized to direct the reactant fluid to the reactant channels in the flow field plates. In addition, further inlet ports, supply manifolds, exhaust manifolds and outlets ports are utilized to direct a coolant fluid to interior passages within the fuel cell stack to absorb heat generated by the exothermic reaction in the fuel cells. The supply and exhaust manifolds may be internal manifolds, which extend through aligned openings formed in the flow field plates and MEAs, or may comprise external or edge manifolds, attached to the edges of the flow field plates.

A broad range of reactants can be used in PEM fuel cells. For example, the fuel stream may be substantially pure hydrogen gas, a gaseous hydrogen-containing reformate stream, or methanol in a direct methanol fuel cell. The oxidant may be, for example, substantially pure oxygen or a dilute oxygen stream such as air.

During normal operation of a PEM fuel cell, fuel is electrochemically oxidized on the anode side, typically resulting in the generation of protons, electrons, and possibly other species depending on the fuel employed. The protons are conducted from the reaction sites at which they are generated, through the membrane, to electrochemically react with the oxidant on the cathode side. The electrons travel through an external circuit providing useable power and then react with the protons and oxidant on the cathode side to generate water reaction product.

Fuel cell stacks are often enclosed in a housing which is suitable for isolating the fuel cell stack from the surrounding environment. As a result, in the event of a leak originating from the fuel cell stack, a fuel cell therein, or any of the manifolds or conduits, the leaked fluid (e.g., the hydrogen-rich gas) will accumulate within the volume of the housing. Typically, there are small accumulations of hydrogen in the housing, as hydrogen leaks cannot in most cases be entirely prevented, hydrogen being a permeating gas. However, as the level of hydrogen accumulation increases, the risk of explosions or fire resulting from the resulting mixture of such hydrogen and the oxygen in the housing increases.

German Patent Application DE 100 31 238 discloses a fuel cell system equipped with a ventilated housing, wherein fans, designed so as not to constitute an ignition source, are used as ventilating means. The ventilated housing addresses the potential safety hazard which can be posed by the accumulation of explosive mixtures of hydrogen and oxygen within the fuel cell system environment.

With respect to the use of recombiners with fuel cell systems, U.S. Patent Application Publication No. 2003/0082428 discloses a fuel cell system comprising a housing containing a recombiner and at least one other component of the fuel cell system, wherein the housing is capable of containing leaked fluids originating from a component of the fuel cell system and the recombiner is capable of converting the leaked fluid into a non-explosive mixture. As disclosed, the recombiner comprises a catalyst coating applied to an interior surface of the housing or to an appropriate support material, which is attached to an interior surface of the housing.

In addition, U.S. Patent Application Publication No. 2005/0014037 discloses a fuel cell or fuel cell stack having a recombination catalyst disposed in the hydrogen and/or oxygen distribution system (e.g., flow fields, manifolds, etc. . . . ) of the fuel cell or fuel cell stack. Again, the recombination catalyst is simply applied as a coating to interior surfaces of the hydrogen and/or oxygen distribution system.

German Patent Application DE 10 2004 020 705 discloses a fuel cell comprising an anode, a cathode and a membrane interposed there between for use as a recombiner in a fuel cell system. During operation of the system, hydrogen transferred to the system's coolant loop is first separated from the coolant in a gas separator and then fed to the fuel cell serving as the recombiner where it is recombined with fresh air in a low temperature reaction. Except for such general disclosure, no further details are given about the design of the fuel cell used as the recombiner.

Accordingly, while advances have been made in this field, there remains a need for systems to address potential accumulation of reactive mixtures, such as hydrogen and oxygen mixtures, within a fuel cell stack environment, particularly within a housing enclosing a stack. The present invention fulfills this need and provides further related advantages.

### BRIEF SUMMARY OF THE INVENTION

In brief, the present invention is directed to a fuel cell system comprising a flame arresting recombiner. More specifically, the present invention is directed to a fuel cell system comprising a housing having an interior space fluidly containing a fuel cell stack and a flame arresting recombiner.

In one embodiment, a fuel cell system is provided comprising a housing having an interior space fluidly containing a fuel cell stack and a flame arresting recombiner, wherein: (1) the flame arresting recombiner comprises at least one fuel cell having at least one anode supply channel fluidly connecting the fuel cell and the interior space of the housing; and (2) the anode supply channel of the fuel cell of the flame arresting recombiner is configured to prevent flame propagation. In a more specific embodiment, the anode supply channel of the fuel cell of the flame arresting recombiner has a depth less than about 0.6 mm and a length of at least about 3.0 mm.

In a further embodiment, the fuel cell of the flame arresting recombiner comprises: (1) an anode and a cathode; (2) an anode plate having an active surface facing the anode and an oppositely facing non-active surface, wherein a plurality of anode flow field channels are formed on the active surface of the anode plate; and (3) a cathode plate having an active surface facing the cathode and an oppositely facing non-active surface.

In another further embodiment, the fuel cell of the flame arresting recombiner may further comprise a membrane disposed between the anode and the cathode.

In another further embodiment, the anode supply channel of the fuel cell of the flame arresting recombiner is formed on the active surface of the anode plate and is fluidly connected to the anode flow field channels.

In another further embodiment, the anode supply channel of the fuel cell of the flame arresting recombiner comprises: (1) at least one anode supply backfeed channel at least partially formed on the non-active surface of the anode plate and configured to prevent flame propagation; (2) an anode supply backfeed port extending through the anode plate; and (3) an anode supply transition region formed on the active surface of the anode plate of the fuel cell and fluidly connected to the anode flow field channels. In a more specific embodiment, the anode supply backfeed channel has a depth less than about 0.6 mm and a length of at least about 3.0 mm.

In another further embodiment, the fuel cell of the flame arresting recombiner further comprises at least one cathode supply channel. In certain embodiments the cathode supply channel of the fuel cell of the flame arresting recombiner may fluidly connect the fuel cell and an oxidant supply. In other embodiments, the cathode supply channel of the fuel cell of the flame arresting recombiner may fluidly connect the fuel cell and the interior space of the housing, and the cathode supply channel of the fuel cell of the flame arresting recombiner may be configured to prevent flame propagation. In a more specific embodiment, the cathode supply channel of the fuel cell of the flame arresting recombiner may have a depth less than about 0.6 mm and a length of at least about 3.0. mm.

In another further embodiment, the fuel cell of the flame arresting recombiner comprises: (1) an anode and a cathode; (2) an anode plate having an active surface facing the anode and an oppositely facing non-active surface, wherein a plurality of anode flow field channels are formed on the active surface of the anode plate; and (3) a cathode plate having an active surface facing the cathode and an oppositely facing non-active surface, wherein a plurality of cathode flow field channels are formed on the active surface of the cathode plate.

In another further embodiment, the fuel cell of the flame arresting recombiner may further comprise a membrane disposed between the anode and the cathode.

In certain embodiments, the anode supply channel of the fuel cell of the flame arresting recombiner is formed on the active surface of the anode plate and is fluidly connected to the anode flow field channels, and the cathode supply channel of the fuel cell of the flame arresting recombiner is formed on the active surface of the cathode plate and is fluidly connected to the cathode flow field channels.

In other embodiments, the anode supply channel of the fuel cell of the flame arresting recombiner comprises: (a) at least one anode supply backfeed channel at least partially formed on the non-active surface of the anode plate and configured to prevent flame propagation; (b) an anode supply backfeed port extending through the anode plate; and (c) an anode supply transition region formed on the active surface of the anode plate of the fuel cell and fluidly connected to the anode flow field channels, and the cathode supply channel of the fuel cell of the flame arresting recombiner comprises: (a) at least one cathode supply backfeed channel at least partially formed on the non-active surface of the cathode plate and configured to prevent flame propagation; (b) a cathode supply backfeed port extending through the cathode plate; and (c) a cathode supply transition region formed on the active surface of the cathode plate of the fuel cell and fluidly connected to the cathode flow field channels. In more specific embodiments, each of the anode and cathode supply backfeed channels has a depth less than about 0.6 mm and a length of at least about 3.0 mm.

In another embodiment, the fuel cell system further comprises a ventilation inlet line fluidly connected to the housing, and a ventilation outlet line fluidly connected to an outlet of the flame arresting recombiner.

In another embodiment, the fuel cell system further comprises a cooling subsystem capable of cooling the flame arresting recombiner. In a further embodiment, the fuel cell of the flame arresting recombiner comprises: (1) an anode and a cathode; (2) an anode plate having an active surface facing the anode and an oppositely facing non-active surface; and (3) a cathode plate having an active surface facing the cathode and an oppositely facing non-active surface, and the cooling subsystem comprises a plurality of coolant flow field channels formed on the non-active surfaces of the anode and cathode plates of the fuel cell.

In another embodiment, the flame arresting recombiner comprises more than one fuel cell.

In another embodiment, the fuel cell of the flame arresting recombiner comprises more than one anode supply channel.

In a further embodiment, the fuel cell of the flame arresting recombiner comprises: (1) an anode and a cathode; (2) an anode plate having an active surface facing the anode and an oppositely facing non-active surface, wherein a plurality of anode flow field channels are formed on the active surface of the anode plate; and (3) a cathode plate having an active surface facing the cathode and an oppositely facing non-active surface; and each of the anode supply channels is fluidly connected to one of the anode flow field channels. In a more specific embodiment, each of the anode supply channels has a depth less than about 0.6 mm and a length of at least about 3.0 mm.

In another further embodiment, the fuel cell of the flame arresting recombiner further comprises more than one cathode supply channel fluidly connecting the fuel cell and the interior space of the housing, and the cathode supply channels of the fuel cell of the flame arresting recombiner are configured to prevent flame propagation.

In yet a further embodiment, the fuel cell of the flame arresting recombiner comprises: (1) an anode and a cathode; (2) an anode plate having an active surface facing the anode and an oppositely facing non-active surface, wherein a plurality of anode flow field channels are formed on the active surface of the anode plate; and (3) a cathode plate having an active surface facing the cathode and an oppositely facing non-active surface, wherein a plurality of cathode flow field channels are formed on the active surface of the cathode plate; each of the anode supply channels is fluidly connected to one of the anode flow field channels; and each of the cathode supply channels is fluidly connected to one of the cathode flow field channels. In a more specific embodiment, each of the anode and cathode supply channels has a depth less than about 0.6 mm and a length of at least about 3.0 mm.

As one of skill in the art will appreciate, further embodiments may be provided by combining the recited elements from one or more of the foregoing embodiments. These and other aspects of the invention will be evident upon reference to the following detailed description and attached drawings.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a diagram of a representative fuel cell system comprising a housing having an interior space fluidly containing a fuel cell stack and a flame arresting recombiner.

FIG. 2 is an exploded sectional view of one representative embodiment of a fuel cell of a flame arresting recombiner.

FIGS. 3A and 3B are plan views of the active and non-active surfaces, respectively, of a separator plate of a second representative embodiment of a fuel cell of a flame arresting recombiner.

FIGS. 4A and 4B are partial plan views of the active and non-active surfaces, respectively, of a separator plate of a third representative embodiment of a fuel cell of a flame arresting recombiner.

FIG. 5 is a partial plan view of the active surface of a separator plate of a fourth representative embodiment of a fuel cell of a flame arresting recombiner.

FIG. 6 is a graph showing the results of the performance tests of a 20-cell fuel cell stack used as a recombiner.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, and fuel cell systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As noted above, the present invention provides a fuel cell system comprising a housing for containing leaked fluids originating from a fuel cell stack and a flame arresting recombiner for converting the leaked fluids into a non-explosive mixture or material.

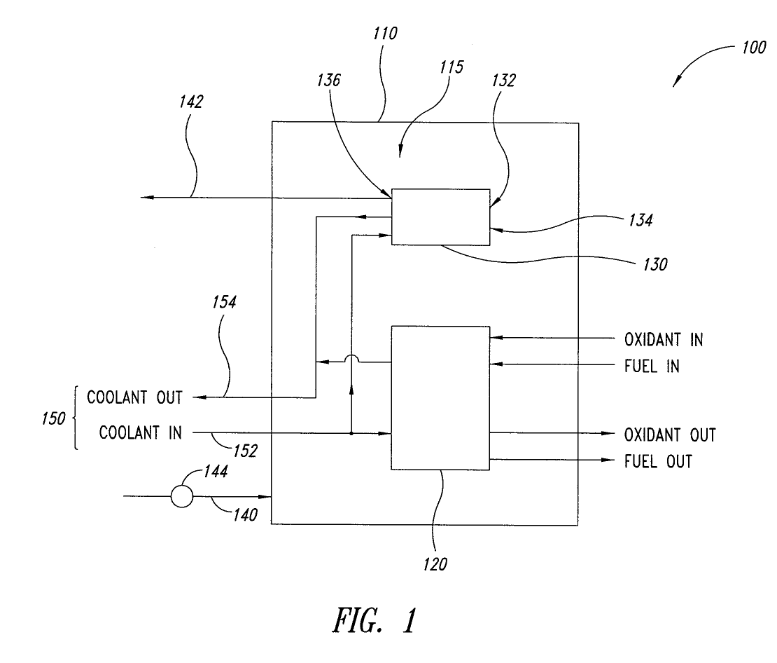

FIG. 1 is a diagram of a representative fuel cell system 100 comprising a housing 110 having an interior space 115 fluidly containing a fuel cell stack 120 and a flame arresting recombiner 130. Housing 110 may be configured to enclose an entire fuel cell stack (as shown), or housing 110 may be configured to enclose one or more additional components of fuel cell system 100, such as a fuel processing subsystem (not specifically shown). In other embodiments, housing 110 may be one of several housings, each enclosing particular components of fuel cell system 100. Depending upon the component being housed in such embodiments, each housing 110 may further include a flame arresting recombiner 130. As these further configurations make use of the principles disclosed herein, such configurations are not separately illustrated and described below.

As shown in FIG. 1, housing 110 encloses fuel cell stack 120 such that fluids leaking out of fuel cell stack 120 (in particular, hydrogen) are contained within the confines of housing 110 and do not reach the surrounding environment. Within flame arresting recombiner 130, the leaked hydrogen accumulating within housing 110 is catalytically recombined with oxygen, either provided from an oxidant supply or contained in the air that is present within housing 110, to form water. Such water is then subsequently drained off in a conventional manner without affecting the sealing characteristics of housing 110. In this way, flame arresting recombiner 130 is used to prevent an increasing hydrogen concentration within the interior of housing 110 and thus prevent the formation of an explosive mixture. The result is a safer operation of fuel cell stack 120.

In conventional recombiners currently employed in fuel cell systems, high temperatures resulting from the recombination of hydrogen and oxygen can cause autoignition of the hydrogen-oxygen fluid mixture, which can lead to dangerous backburning into other components of the fuel cell system. The flame arresting recombiner 130 of the present invention, on the other hand, comprises at least one fuel cell having at least one anode supply channel 132 (not shown in detail in FIG. 1), fluidly connecting the fuel cell and interior space 115 of housing 110, that is configured to prevent flame propagation. In this way, flame arresting recombiner 130 prevents such backburning.

As one of skill in the art will appreciate, the terms “configured to prevent flame propagation” mean that the aperture through which the burning hydrogen/air mixture enters is narrow enough such that the heat generated by the flame is conducted to the surrounding walls to make the combustion process cease. For example, in more specific embodiments, anode supply channel 132 has a depth less than about 0.6 mm (the flame quench distance for a stoichiometric hydrogen-air mixture) and a length of at least about 3.0 mm.

In addition, as one of skill in the art will appreciate, the terms “fluidly connected” mean that the described elements (e.g., the fuel cell of flame arresting recombiner 130 and interior space 115 of housing 110 of FIG. 1) are fluidly connected either directly or through one or more additional elements.

As further shown in FIG. 1, in certain embodiments, fuel cell system 100 may comprise a ventilation inlet line 140 (which may comprise a fan or vent blower 144) fluidly connected to housing 110 and a ventilation outlet line 142 fluidly connected to an outlet 136 of flame arresting recombiner 130. During operation of such embodiments, fluid flow from ventilation inlet line 140 (and fan or vent blower 144, if present) directs leaked fluids (such as hydrogen) which have accumulated in interior space 115 of housing 100 into anode supply channel 132 of flame arresting recombiner 130. Any water produced by the recombination reaction in flame arresting recombiner 130, as well as any unreacted fluids (such as hydrogen and oxygen), are discharged through ventilation outlet line 142.

As further shown in FIG. 1, in certain embodiments, the at least one fuel cell (not specifically shown) of flame arresting recombiner 130 may further comprise at least one cathode supply channel 134 (not shown in detail in FIG. 1). Cathode supply channel 134 may fluidly connect the fuel cell and an oxidant supply, or cathode supply channel 134 may fluidly connect the fuel cell and interior space 115 of housing 110. In embodiments wherein cathode supply channel 134 fluidly connects the fuel cell and interior space 115, similar to anode supply channel 132, cathode supply channel 134 is configured to prevent flame propagation.

As further shown in FIG. 1, in certain embodiments, fuel cell system 100 may further comprise a cooling subsystem 150 capable of cooling flame arresting recombiner 130. For example, as shown in FIG. 1, cooling subsystem 150 comprises a coolant inlet line 152, capable of directing coolant to flame arresting recombiner 130, and a coolant outlet line 154, capable of directing coolant away from flame arresting recombiner 130. Cooling subsystem 150 may be utilized to maintain the temperature of flame arresting recombiner 130 (in particular, anode and cathode supply channels 132 and 134) below the autoignition temperature of a hydrogen-air mixture, which is about 525 to 570° C.

As one of skill in the art will appreciate, in embodiments comprising cooling subsystem 150, flame arresting recombiner 130 could be used as a “micro-heating loop” wherein heat from the recombination reaction occurring within flame arresting recombiner 130 may be used to pre-warm coolant in cooling subsystem 150 thereby aiding in the start-up of fuel cell stack 120 from cold or sub-zero temperatures.

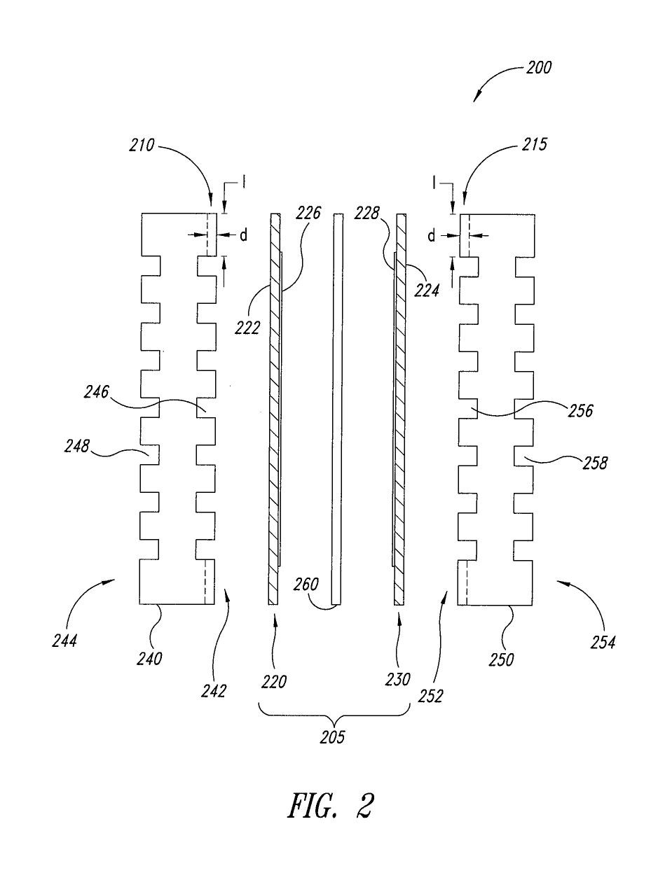

FIG. 2 is an exploded sectional view of one representative embodiment of a fuel cell 200 of a flame arresting recombiner of the present invention, such as flame arresting recombiner 130 of FIG. 1. Fuel cell 200 includes a MEA 205 interposed between anode separator plate 240 and cathode separator plate 250. In the illustrated embodiment, MEA 205 comprises a polymer electrolyte membrane 260 interposed between two electrodes, namely, anode 220 and cathode 230. As in conventional fuel cells, anode 220 and cathode 230 may each comprise a gas diffusion layer (i.e., a fluid distribution layer of porous electrically conductive sheet material) 222 and 224, respectively. Each fluid distribution layer has a thin layer of recombination catalyst 226 and 228 disposed on the surface thereof at the interface with membrane 260 to render each electrode electrochemically active. Suitable recombination catalysts include platinum or alloys thereof, palladium, gold, tin, and combinations thereof, with or without platinum. Still other suitable recombination catalysts include, for example, noble metals, nickel-palladium, and nickel oxides.

Anode plate 240 has at least one anode flow field channel 246 formed on its active surface 242 facing anode 220. Similarly, cathode plate 250 has at least one cathode flow field channel 256 formed on its active surface 252 facing cathode 230. When assembled against the cooperating surfaces of anode and cathode 220 and 230, respectively, anode and cathode flow field channels 246 and 256 form reactant flow field passages to anode 220 and cathode 230, respectively.

As shown in FIG. 2, fuel cell 200 comprises at least one anode supply channel 210 fluidly connected to anode flow field channels 246 of fuel cell 200. Anode supply channel 210 has a depth (d) and a length (l), which dimensions are selected in order to prevent flame propagation. As noted above with respect to FIG. 1, in certain embodiments, anode supply channel 210 has a depth (d) less than about 0.6 mm and a length (l) of at least about 3.0 mm. As one of skill in the art will appreciate, the depth (d) of anode supply channel may or may not be the same as the depth of anode flow field channels 246.

As further shown in FIG. 2, fuel cell 200 comprises at least one cathode supply channel 215 fluidly connected to cathode flow field channels 256 of fuel cell 200. Cathode supply channel 215 may fluidly connect fuel cell 200 (namely, cathode flow field channels 256) and an oxidant supply, or cathode supply channel 215 may fluidly connect fuel cell 200 (namely, cathode flow field channels 256) and the interior space of the surrounding housing. In embodiments wherein cathode supply channel 215 fluidly connects cathode flow field channels 256 to the interior space of the surrounding housing 115, cathode supply channel 215 is configured to prevent flame propagation. Similar to anode supply channel 210, cathode supply channel 215 has a depth (d) and a length (l), which dimensions are selected in order to prevent flame propagation. As noted above with respect to FIG. 1, in certain embodiments, cathode supply channel 215 has a depth (d) less than about 0.6 mm and a length (l) of at least about 3.0 mm. In addition, as one of skill in the art will appreciate the depth (d) of cathode supply channel 215 may or may not be the same as the depth of cathode flow field channels 256.

As further shown in FIG. 2, both anode and cathode plates 240 and 250 have non-active surfaces 244 and 254, respectively, on the opposite facing sides of the plates from active surfaces 242 and 252, respectively. Both anode and cathode plates 240 and 250 have a plurality of coolant flow field channels 248 and 258, respectively, formed on such non-active surfaces 244 and 254, respectively. Such coolant flow field channels 248 and 258 may be utilized to direct coolant from a cooling subsystem (such as cooling subsystem 150 in FIG. 1) to fuel cell 200 and, thereby, cool the flame arresting recombiner comprising fuel cell 200.

In a flame arresting recombiner comprising more than one fuel cell (for example, a flame arresting recombiner comprising a fuel cell stack), a plurality of fuel cells 200 are arranged in series, such that, with respect to a single fuel cell 200, anode plate 240 is adjacent to the cathode plate 250 of one of the two adjacent fuel cells 200 and cathode plate 250 is adjacent to the anode plate 240 of the other adjacent fuel cell 200 (i.e., anode 220 faces the cathode 230 of one adjacent fuel cell 200 and cathode 230 faces the anode 220 of the other adjacent fuel cell 200).

As noted above, in the embodiment illustrated in FIG. 2, fuel cell 200 comprises a membrane 260 disposed between the anode 220 and cathode 230. However, in other embodiments, membrane 260 may not be present. In such an embodiment, fuel cell 200 merely comprises anode 220 and cathode 230 disposed face-to-face. As one of skill in the art will appreciate, in the illustrated embodiment, fuel cell 200 may be utilized as a source of electric current if the reactant (e.g., fuel/air) mixture is supplied to only one side of the separating membrane 260, whereas in the alternate embodiment (wherein membrane 260 is not present), no electric current is generated.

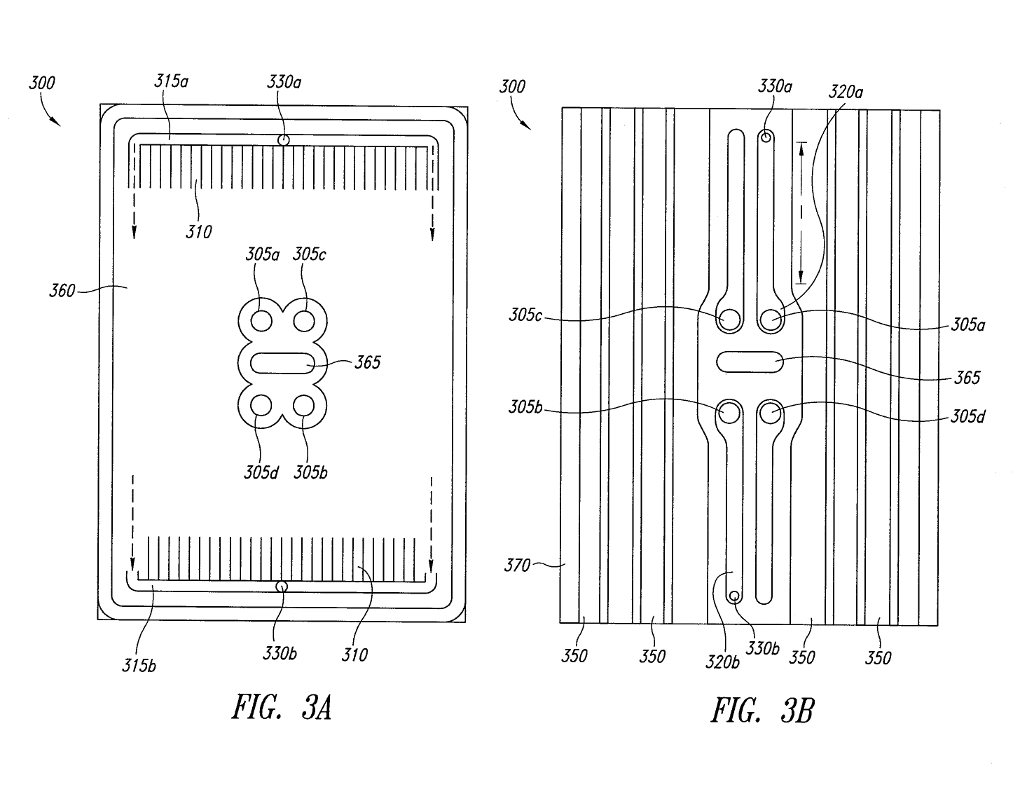

FIGS. 3A and 3B are plan views of the active 360 and non-active 370 surfaces, respectively, of an anode or cathode separator plate 300 of a second representative embodiment of a fuel cell (comprising internal reactant manifolds) of a flame arresting recombiner of the present invention, such as flame arresting recombiner 130 of FIG. 1. Reactant (i.e., anode or cathode) plate 300 has openings extending therethrough, namely, reactant supply and exhaust manifold openings 305a-d, and tie rod opening 365. FIG. 3A depicts the active surface 360 of reactant plate 300 which, in a fuel cell or fuel cell stack, faces a MEA (which, as in the embodiment illustrated in FIG. 2, may or may not comprise a membrane). Reactant flow field channels, only a portion of which are shown (for clarity) as 310, distribute a reactant fluid to the contacted electrode layer of the MEA. Reactant flow field channels 310 may comprise one or more continuous or discontinuous channels. The reactant fluid is supplied to, and exhausted from, reactant flow field channels 310 from the oppositely facing non-active surface 370 of reactant plate 300 via reactant supply and exhaust backfeed ports 330a, 330b, respectively, which extend through the reactant plate 300, and reactant supply and exhaust transition regions 315a, 315b, respectively, which are formed on active surface 360 of reactant plate 300. FIG. 3B depicts the oppositely facing non-active surface 370 of reactant plate 300. FIG. 3B shows how reactant supply and exhaust backfeed ports 330a, 330b are fluidly connected to reactant supply and exhaust backfeed channels 320a, 320b, respectively, which in turn are fluidly connected to reactant supply and exhaust reactant manifold openings 305a, 305b, respectively. Accordingly, taken collectively, reactant supply and exhaust transition regions 315a, 315b, backfeed ports 330a, 330b, and backfeed channels 320a, 320b comprise reactant supply and exhaust channels fluidly connecting reactant flow field channels 310 to supply and exhaust manifold openings 305a, 305b.

Although not specifically illustrated in FIG. 3B, reactant supply backfeed channel 320a is configured to prevent flame propagation. Similar to anode and cathode supply channels 210 and 215 of FIG. 2, reactant supply backfeed channel 320a has a depth (d) (not specifically shown) and a length (l), which dimensions are selected in order to prevent flame propagation. As noted above with respect to FIG. 1, in certain embodiments, reactant supply backfeed channel 320a has a depth (d) less than about 0.6 mm and a length (l) of at least about 3.0 mm.

As further shown in FIG. 3B, multiple coolant flow field channels 350 are also formed on the non-active surface 370 of plate 300. Thus, channels for both reactants and for a coolant traverse a portion of the non-active surface 370 of plate 300. The illustrated coolant channels 350 are suitable for an open cooling system which uses air as the coolant. For example, cooling air may be blown through the channels by a fan or blower. For low power fuel cells, such as portable units, it may be possible to operate a fuel cell stack without a fan by relying only on the transfer of heat from the surfaces of cooling channels 250 to the ambient air. Alternatively, a closed cooling system (not shown), which typically employs stack coolant manifolds (which could be internal, edge or external manifolds) fluidly connected to an array of coolant channels, could be utilized.

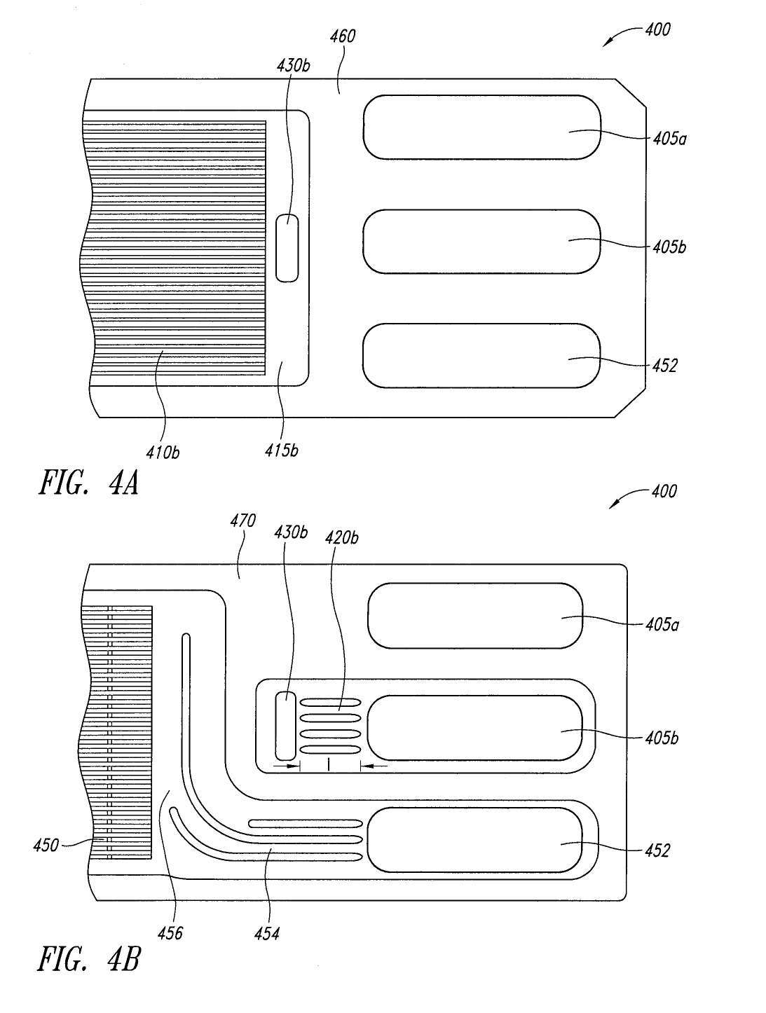

FIGS. 4A and 4B are partial plan views of the active 460 and non-active 470 surfaces, respectively, of a reactant separator plate 400 of a third representative embodiment of a fuel cell (having end reactant manifolds—i.e., manifolds positioned along the edge of the plate perpendicular to the direction of the flow field channels) of a flame arresting recombiner of the present invention, such as flame arresting recombiner 130 of FIG. 1. As shown, reactant plate 400 has openings extending therethrough, namely, reactant supply manifold openings 405a, 405b and coolant supply manifold opening 452, which, when assembled into a fuel cell or fuel cell stack, form end reactant and coolant supply manifolds extending through the cell or stack. In more specific embodiments, for example, reactant supply manifold opening 405a may be an anode supply manifold opening, and reactant supply manifold opening 405b may be a cathode supply manifold opening.

FIG. 4A depicts the active surface 460 of reactant plate 400 which, in a fuel cell or fuel cell stack, faces a MEA (which, as in the embodiment illustrated in FIG. 2, may or may not comprise a membrane). Reactant flow field channels 410b distribute a reactant fluid to the contacted electrode of the MEA. Reactant flow field channels 410b may comprise one or more continuous or discontinuous channels. The reactant fluid is supplied to reactant flow field channels 410b from the oppositely facing non-active surface 470 of reactant plate 400 via reactant supply backfeed port 430b, which extends through reactant plate 400, and reactant supply transition region 415b, formed on active surface 460 of plate 400. FIG. 4B depicts the oppositely facing non-active surface 470 of reactant plate 400. FIG. 4B shows how reactant supply backfeed port 430b is fluidly connected to reactant supply backfeed channels 420b, which in turn are fluidly connected to reactant supply manifold opening 405b. Accordingly, taken collectively, reactant supply transition region 415b, reactant supply backfeed port 430b, and reactant supply backfeed channels 420b comprise reactant supply channels fluidly connecting reactant flow field channels 410b to reactant supply manifold opening 405b.

Although not specifically illustrated in FIGS. 4A and 4B, reactant supply backfeed channels 420b are configured to prevent flame propagation. Similar to anode and cathode supply channels 210 and 215 of FIG. 2, and reactant supply backfeed channel 320a of FIG. 3B, reactant supply backfeed channels 420b have a depth (d) (not specifically shown) and a length (l), which dimensions are selected in order to prevent flame propagation. For example, as noted above with respect to FIG. 1, in certain embodiments, reactant supply backfeed channels 420b have a depth (d) less than about 0.6 mm and a length (l) of at least about 3.0 mm.

As further shown in FIG. 4B, a plurality of coolant flow field channels 450 are also formed on the non-active surface 470 of plate 400. Coolant flow field channels 450 are fluidly connected to coolant supply manifold opening 452 via coolant supply passageways comprising coolant supply transition region 456 and coolant supply backfeed channels 454, also formed on the non-active surface 470 of plate 400.

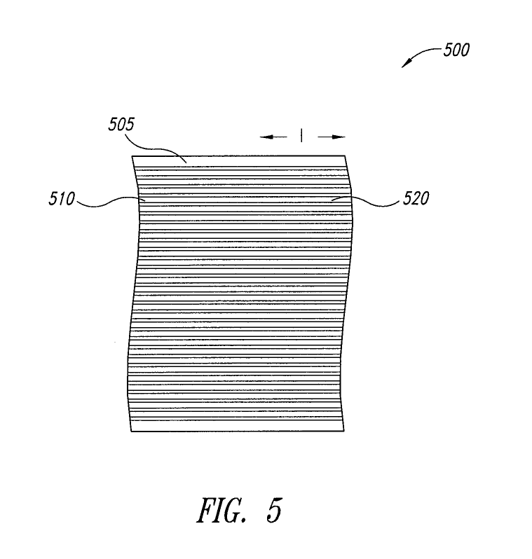

FIG. 5 is a partial plan view of the active surface 505 of a reactant separator plate 500 of a fourth representative embodiment of a fuel cell of a flame arresting recombiner of the present invention, such as flame arresting recombiner 130 of FIG. 1. As shown, active surface 505 of reactant plate 500, which, in a fuel cell or fuel cell stack, faces an MEA (which, as in the embodiment of Figure illustrated in FIG. 2, may or may not comprise a membrane), comprises reactant flow field channels 510 which distribute a reactant fluid to the contacted electrode of the MEA. Reactant flow field channels 510 may comprise one or more discontinuous channels.

As further shown in FIG. 5, each of the reactant flow field channels 510 is fluidly connected to a reactant supply channel 520. As one of skill in the art will appreciate, reactant supply channels 520 and reactant flow field channels 510 may be separate, fluidly connected elements or reactant supply channel 520 may comprise upstream portions of reactant flow field channels 5 10. Although not specifically illustrated in FIG. 5, reactant supply channels 520 are configured to prevent flame propagation. Similar to anode and cathode supply channels 210 and 215 of FIG. 2, reactant supply backfeed channel 320a of FIG. 3B, and reactant supply backfeed channels 420b of FIG. 4B, reactant supply channels 520 have a depth (d) (not specifically shown) and a length (l), which dimensions are selected in order to prevent flame propagation. For example, as noted above with respect to FIG. 1, in certain embodiments, reactant supply channels 520 have a depth (d) less than about 0.6 mm and a length (l) of at least about 3.0 mm.

Reactant supply channels 520 may fluidly connect reactant flow field channels 510 to a reactant source (such as the interior space 115 of housing 110 in FIG. 1) directly or through one or more additional elements, such as internal and end reactant manifolds, reactant supply ports, reactant supply transition regions and reactant supply backfeed channels. In this way, the embodiment illustrated in FIG. 5, namely, an embodiment comprising both a plurality of reactant flow field channels and a plurality of reactant supply channels, may be utilized in lieu of, or in combination with the embodiments illustrated in FIGS. 2, 3A, 3B, 4A and 4B. For example, in a fuel cell comprising internal reactant manifolds and reactant plates having reactant backfeed channels, similar to reactant plate 300 of FIGS. 3A and 3B, the reactant flow field channels (such as reactant flow field channels 310) may be replaced with fluidly connected reactant supply channels and reactant flow field channels (such as reactant supply channels 520 and reactant flow field channels 510). In such an embodiment, it would not be necessary to configure the reactant backfeed channels to prevent flame propagation.

### EXAMPLES

### Example 1

A 20-cell liquid cooled fuel cell stack, wherein each fuel cell included an anode, a cathode and a polymer electrolyte membrane there between, was used to recombine the hydrogen from an incoming air-hydrogen mixture into water. The stack was placed on a test bench and was not enclosed in a casing. The stack was not connected to a load. A hydrogen/air mixture over a range of 0 to 67% H₂ by volume in the input air flow was fed to both the cathode and anode of the recombining stack. The H₂ concentration at the stack outlet was measured, as well as the O₂ concentration and the temperature rise across the stack at a fixed coolant flow rate (around 2 lpm of water through the coolant channels). Tests were conducted at an air flow of 50 slpm.

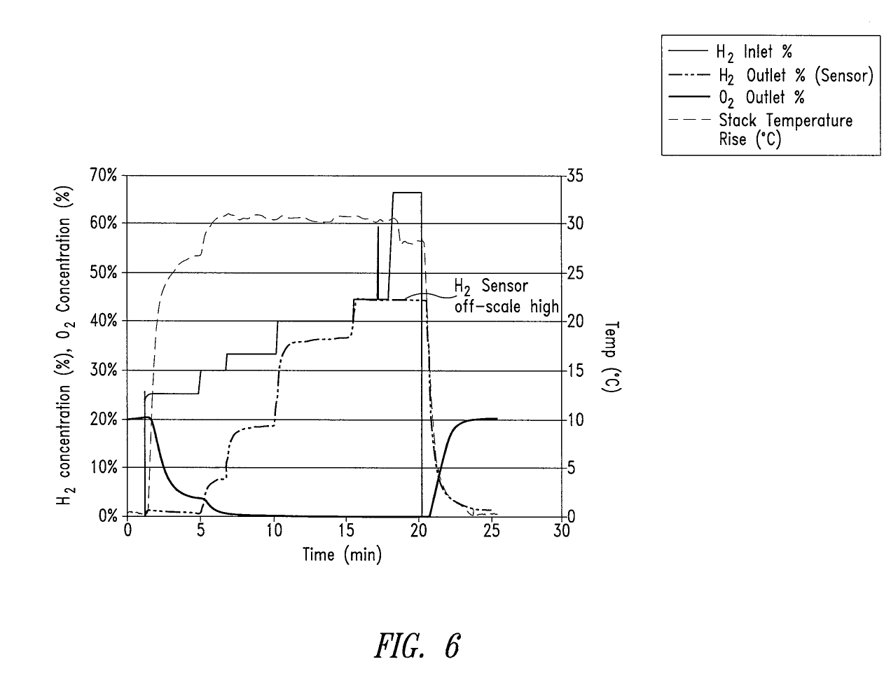

As shown in FIG. 6, the tests showed excellent recombination at 25% hydrogen in the hydrogen/air mixture at the inlet, respectively around 1% hydrogen concentration at the outlet. Outlet hydrogen concentration remained close to the same value for all hydrogen inlet concentrations below 30% and the maximum temperature measured at the stack coolant outlet was approximately 44° C. The gas stream downstream of the stack was never flammable, as the oxygen concentration dropped below the flammable range before any hydrogen began to appear in the outlet. The tests also show oxygen depletion to less than 5% oxygen on the ramp to 30% hydrogen concentration in the hydrogen/air mixture at the inlet, therefore preventing any flame occurrence.

While particular steps, elements, embodiments and applications of the present invention have been shown and described herein for purposes of illustration, it will be understood, of course, that the invention is not limited thereto since modifications may be made by persons skilled in the art, particularly in light of the foregoing teachings, without deviating from the spirit and scope of the invention. Accordingly, the invention is not limited except as by the appended claims.

What is claimed is:

1. A fuel cell system comprising a housing having an interior space fluidly containing a fuel cell stack and a flame arresting recombiner, wherein:
the flame arresting recombiner comprises at least one fuel cell having at least one anode supply channel fluidly connecting the fuel cell and the interior space of the housing; and
the anode supply channel of the fuel cell of the flame arresting recombiner is configured to prevent flame propagation.

2. The fuel cell system of claim 1 wherein the anode supply channel of the fuel cell of the flame arresting recombiner has a depth less than about 0.6 mm and a length of at least about 3.0 mm.

3. The fuel cell system of claim 1 wherein the fuel cell of the flame arresting recombiner comprises:
an anode and a cathode;
an anode plate having an active surface facing the anode and an oppositely facing non-active surface, wherein a plurality of anode flow field channels are formed on the active surface of the anode plate; and
a cathode plate having an active surface facing the cathode and an oppositely facing non-active surface.

4. The fuel cell system of claim 3 wherein the fuel cell of the flame arresting recombiner further comprises a membrane disposed between the anode and the cathode.

5. The fuel cell system of claim 3 wherein the anode supply channel of the fuel cell of the flame arresting recombiner is formed on the active surface of the anode plate and is fluidly connected to the anode flow field channels.

6. The fuel cell system of claim 3 wherein the anode supply channel of the fuel cell of the flame arresting recombiner comprises:
at least one anode supply backfeed channel at least partially formed on the non-active surface of the anode plate and configured to prevent flame propagation;
an anode supply backfeed port extending through the anode plate; and
an anode supply transition region formed on the active surface of the anode plate of the fuel cell and fluidly connected to the anode flow field channels.

7. The fuel cell system of claim 6 wherein the anode supply backfeed channel has a depth less than about 0.6 mm and a length of at least about 3.0 mm.

8. The fuel cell system of claim 1 wherein the fuel cell of the flame arresting recombiner further comprises at least one cathode supply channel.

9. The fuel cell system of claim 8 wherein the cathode supply channel of the fuel cell of the flame arresting recombiner fluidly connects the fuel cell and an oxidant supply.

10. The fuel cell system of claim 8 wherein the cathode supply channel of the fuel cell of the flame arresting recombiner fluidly connects the fuel cell and the interior space of the housing, and wherein the cathode supply channel of the fuel cell of the flame arresting recombiner is configured to prevent flame propagation.

11. The fuel cell system of claim 10 wherein the cathode supply channel of the fuel cell of the flame arresting recombiner has a depth less than about 0.6 mm and a length of at least about 3.0 mm.

12. The fuel cell system of claim 10 wherein the fuel cell of the flame arresting recombiner comprises:
an anode and a cathode;
an anode plate having an active surface facing the anode and an oppositely facing non-active surface, wherein a plurality of anode flow field channels are formed on the active surface of the anode plate; and
a cathode plate having an active surface facing the cathode and an oppositely facing non-active surface, wherein a plurality of cathode flow field channels are formed on the active surface of the cathode plate.

13. The fuel cell system of claim 12 wherein the fuel cell of the flame arresting recombiner further comprises a membrane disposed between the anode and the cathode.

14. The fuel cell system of claim 12 wherein:
the anode supply channel of the fuel cell of the flame arresting recombiner is formed on the active surface of the anode plate and is fluidly connected to the anode flow field channels; and
the cathode supply channel of the fuel cell of the flame arresting recombiner is formed on the active surface of the cathode plate and is fluidly connected to the cathode flow field channels.

15. The fuel cell system of claim 12 wherein:
the anode supply channel of the fuel cell of the flame arresting recombiner comprises:
(a) at least one anode supply backfeed channel at least partially formed on the non-active surface of the anode plate and configured to prevent flame propagation;
(b) an anode supply backfeed port extending through the anode plate; and
(c) an anode supply transition region formed on the active surface of the anode plate of the fuel cell and fluidly connected to the anode flow field channels; and
the cathode supply channel of the fuel cell of the flame arresting recombiner comprises:
(a) at least one cathode supply backfeed channel at least partially formed on the non-active surface of the cathode plate and configured to prevent flame propagation;
(b) a cathode supply backfeed port extending through the cathode plate; and
(c) a cathode supply transition region formed on the active surface of the cathode plate of the fuel cell and fluidly connected to the cathode flow field channels.

16. The fuel cell system of claim 15 wherein each of the anode and cathode supply backfeed channels has a depth less than about 0.6 mm and a length of at least about 3.0 mm.

17. The fuel cell system of claim 1, further comprising:
a ventilation inlet line fluidly connected to the housing; and
a ventilation outlet line fluidly connected to an outlet of the flame arresting recombiner.

18. The fuel cell system of claim 1, further comprising a cooling subsystem capable of cooling the flame arresting recombiner.

19. The fuel cell system of claim 18 wherein the fuel cell of the flame arresting recombiner comprises:
an anode and a cathode;
an anode plate having an active surface facing the anode and an oppositely facing non-active surface; and
a cathode plate having an active surface facing the cathode and an oppositely facing non-active surface,
and wherein the cooling subsystem comprises a plurality of coolant flow field channels formed on the non-active surfaces of the anode and cathode plates of the fuel cell.

20. The fuel cell system of claim 1 wherein the flame arresting recombiner comprises more than one fuel cell.

21. The fuel cell system of claim 1 wherein the fuel cell of the flame arresting recombiner comprises more than one anode supply channel.

22. The fuel cell system of claim 21 wherein:
the fuel cell of the flame arresting recombiner comprises:
an anode and a cathode;
an anode plate having an active surface facing the anode and an oppositely facing non-active surface, wherein a plurality of anode flow field channels are formed on the active surface of the anode plate; and
a cathode plate having an active surface facing the cathode and an oppositely facing non-active surface; and
each of the anode supply channels is fluidly connected to one of the anode flow field channels.

23. The fuel cell system of claim 22 wherein each of the anode supply channels has a depth less than about 0.6 mm and a length of at least about 3.0 mm.

24. The fuel cell system of claim 21 wherein:
the fuel cell of the flame arresting recombiner further comprises more than one cathode supply channel fluidly connecting the fuel cell and the interior space of the housing; and
the cathode supply channels of the fuel cell of the flame arresting recombiner are configured to prevent flame propagation.

25. The fuel cell system of claim 24 wherein:
the fuel cell of the flame arresting recombiner comprises:
an anode and a cathode;
an anode plate having an active surface facing the anode and an oppositely facing non-active surface, wherein a plurality of anode flow field channels are formed on the active surface of the anode plate; and
a cathode plate having an active surface facing the cathode and an oppositely facing non-active surface, wherein a plurality of cathode flow field channels are formed on the active surface of the cathode plate;
each of the anode supply channels is fluidly connected to one of the anode flow field channels; and
each of the cathode supply channels is fluidly connected to one of the cathode flow field channels.

26. The fuel cell system of claim 25 wherein each of the anode and cathode supply channels has a depth less than about 0.6 mm and a length of at least about 3.0 mm.
